(19) United States
(12) Patent Application Publication
(10) Pub. No.: US 2024/0205763 A1
(43) Pub. Date: Jun. 20, 2024

(54) METHODS AND APPARATUSES FOR STORING AND REPORTING INFORMATION RELATING TO A PSCELL CHANGE PROCEDURE

(71) Applicant: LENOVO (BEIJING) LIMITED, Beijing (CN)

(72) Inventors: Le Yan, Shanghai (CN); Lianhai Wu, Beijing (CN); Mingzeng Dai, Shanghai (CN); Congchi Zhang, Shanghai (CN)

(21) Appl. No.: 18/555,373

(22) PCT Filed: Apr. 13, 2021
(86) PCT No.: PCT/CN2021/087036

§ 371 Date: Oct. 13, 2023

(51) Int. Cl. H04W 36/00; H04W 36/08

(52) U.S. Cl. CPC H04W 36/0069; H04W 36/0011; H04W 36/08

(57) ABSTRACT

Embodiments of the present disclosure relate to methods and apparatuses for storing and/or reporting information relating to a primary secondary cell (PSCell) change procedure in a multi-radio dual connectivity (MR-DC) scenario and/or a LTE-LTE DC scenario. According to an embodiment of the present disclosure, a method which may be performed by a UE includes: detecting a presence of a trigger condition before or during a PSCell change procedure from a source PSCell to a target PSCell in relation to the UE or after successfully completing the PSCell change procedure: and in response to detecting the presence of the trigger condition, storing information relating to the PSCell change procedure.

### TECHNICAL FIELD

The present application generally relates to wireless communication technology, and especially to methods and apparatuses for storing and/or reporting information relating to a primary secondary cell (PSCell) change procedure in a multi-radio dual connectivity (MR-DC) scenario and/or a long term evolution (LTE)-LTE DC scenario.

### BACKGROUND

Next generation radio access network (NG-RAN) supports a MR-DC operation. In a MR-DC scenario, a user equipment (UE) with multiple transceivers may be configured to utilize resources provided by two different nodes connected via non-ideal backhauls. Wherein one node may provide new radio (NR) access and the other one node may provide either Evolved Universal Terrestrial Radio Access (E-UTRA) or NR access. One node may act as a master node (MN) and the other node may act as a secondary node (SN). The MN and SN are connected via a network interface (for example, a Xn interface or a X2 interface as specified in 3rd Generation Partnership Project (3GPP) standard documents), and at least the MN is connected to the core network. A MR-DC case includes a NR-NR DC case, a EN-DC case, a NGEN-DC case, and/or a NE-DC case.

Currently, in a wireless communication system or network, details of storing and/or reporting information relating to a PSCell change procedure in a MR-DC scenario and/or a LTE-LTE DC scenario have not been discussed yet.

### SUMMARY

Some embodiments of the present application provide a method, which may be performed by a UE. The method includes: detecting a presence of a trigger condition before or during a PSCell change procedure from a source PSCell to a target PSCell in relation to the UE or after successfully completing the PSCell change procedure; and in response to detecting the presence of the trigger condition, storing information relating to the PSCell change procedure.

Some embodiments of the present application also provide a UE. The UE includes a processor and a wireless transceiver coupled to the processor; and the processor is configured: to detect a presence of a trigger condition before or during a PSCell change procedure from a source PSCell to a target PSCell in relation to the UE or after successfully completing the PSCell change procedure; and to store information relating to the PSCell change procedure, in response to detecting the presence of the trigger condition.

Some embodiments of the present application provide an apparatus. The apparatus includes: a non-transitory computer-readable medium having stored thereon computer-executable instructions, a receiving circuitry; a transmitting circuitry; and a processor coupled to the non-transitory computer-readable medium, the receiving circuitry and the transmitting circuitry, wherein the computer-executable instructions cause the processor to implement any of the abovementioned methods performed by a UE.

Some further embodiments of the present application provide a method, which may be performed by a radio access network (RAN) node, e.g., a MN. The method includes: transmitting, to a UE, a radio resource control (RRC) reconfiguration message for triggering a PSCell change procedure; and receiving, from the UE, an indication for information relating to the PSCell change procedure.

Some embodiments of the present application also provide a MN. The MN includes a processor and a wireless transceiver coupled to the processor; and the processor is configured: to transmit, via the wireless transceiver, a RRC reconfiguration message to a UE; and to receive from the UE, via the wireless transceiver, an indication for information relating to a PSCell change procedure.

Some embodiments of the present application provide a method for wireless communications. The method may be performed by a RAN node, e.g., a source SN. The method includes: initiating a PSCell change procedure in relation to a UE; and receiving a message, wherein the message includes information relating to the PSCell change procedure.

Some embodiments of the present application also provide a source SN. The source SN includes a processor and a wireless transceiver coupled to the processor; and the processor is configured: to initiate a PSCell change procedure in relation to a UE; and to receive a message via the wireless transceiver, wherein the message includes information relating to the PSCell change procedure.

Some embodiments of the present application provide a method, which may be performed by a RAN node, e.g., a target SN. The method includes: participating a PSCell change procedure; and receiving a message, wherein the message includes information relating to the PSCell change procedure.

Some embodiments of the present application also provide a target SN. The target SN includes a processor and a wireless transceiver coupled to the processor; and the processor is configured: to participate in a PSCell change procedure in relation to a UE; and to receive a message via the wireless transceiver, wherein the message includes information relating to the PSCell change procedure.

Some embodiments of the present application provide an apparatus for wireless communications. The apparatus comprises: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the abovementioned methods performed by a RAN node.

The details of one or more examples are set forth in the accompanying drawings and the description below. Other features, objects, and advantages will be apparent from the description and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application;

FIG. 2 illustrates an exemplary flow chart of a method for storing information relating to a PSCell change procedure according to some embodiments of the present application;

FIG. 3 illustrates an exemplary flow chart of a method for receiving an indication for information relating to a PSCell change procedure according to some embodiments of the present application;

FIG. 4 illustrates an exemplary flow chart of a method for receiving information relating to a PSCell change procedure according to some embodiments of the present application;

FIG. 5 illustrates a further exemplary flow chart of a method for receiving information relating to a PSCell change procedure according to some embodiments of the present application;

FIG. 6 illustrates an exemplary flow chart of a MN initiated PSCell change procedure according to some embodiments of the present application;

FIG. 7 illustrates an exemplary flow chart of a SN initiated PSCell change procedure according to some embodiments of the present application;

FIG. 8 illustrates a further exemplary flow chart of a SN initiated PSCell change procedure according to some embodiments of the present application; and

FIG. 9 illustrates an exemplary block diagram of an apparatus according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8, B5G, 6G, and so on. It is contemplated that along with developments of network architectures and new service scenarios, all embodiments in the present application are also applicable to similar technical problems; and moreover, the terminologies recited in the present application may change, which should not affect the principle of the present application.

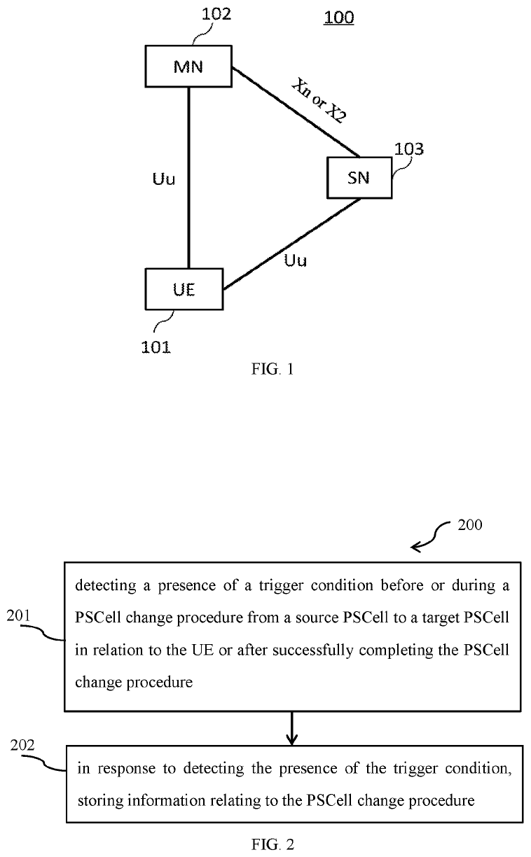

FIG. 1 illustrates a schematic diagram of a wireless communication system in accordance with some embodiments of the present application.

As shown in FIG. 1, the wireless communication system 100 may be a dual connectivity system 100, including at least one UE 101, at least one MN 102, and at least one SN 103. In particular, the dual connectivity system 100 in FIG. 1 includes one shown UE 101, one shown MN 102, and one shown SN 103 for illustrative purpose. Although a specific number of UEs 101, MNs 102, and SNs 103 are depicted in FIG. 1, it is contemplated that any number of UEs 101, MNs 102, and SNs 103 may be included in the wireless communication system 100.

Referring to FIG. 1, UE 101 may be connected to MN 102 and SN 103 via a network interface, for example, the Uu interface as specified in 3GPP standard documents. MN 102 and SN 103 may be connected with each other via a network interface, for example, a Xn interface or a X2 interface as specified in 3GPP standard documents. MN 102 may be connected to the core network via a network interface (not shown in FIG. 1). UE 102 may be configured to utilize resources provided by MN 102 and SN 103 to perform data transmission.

MN 102 may refer to a radio access node that provides a control plane connection to the core network. In an embodiment of the present application, in the E-UTRA-NR Dual Connectivity (EN-DC) scenario, MN 102 may be an eNB. In a further embodiment of the present application, in the LTE-LTE DC scenario, MN 102 may be an eNB. In another embodiment of the present application, in the next generation E-UTRA-NR Dual Connectivity (NGEN-DC) scenario, MN 102 may be an ng-eNB. In yet another embodiment of the present application, in the NR-E-UTRA Dual Connectivity (NE-DC) scenario or the NR-NR Dual Connectivity (NR-DC) scenario, MN 102 may be a gNB.

MN 102 may be associated with a master cell group (MCG). The MCG may refer to a group of serving cells associated with MN 102, and may include a primary cell (PCell) and optionally one or more secondary cells (SCells) of the MCG. The PCell may provide a control plane connection to UE 101.

SN 103 may refer to a radio access node without a control plane connection to the core network but providing additional resources to UE 101. In an embodiment of the present application, in the EN-DC scenario, SN 103 may be an en-gNB. In a further embodiment of the present application, in the LTE-LTE DC scenario, SN 103 may be an eNB. In another embodiment of the present application, in the NE-DC scenario, SN 103 may be a ng-eNB. In yet another embodiment of the present application, in the NR-DC scenario or the NGEN-DC scenario, SN 103 may be a gNB.

SN 103 may be associated with a secondary cell group (SCG). The SCG may refer to a group of serving cells associated with SN 103, and may include a primary cell of a second cell group (PSCell) and optionally one or more secondary cells (SCells). The PCell of the MCG and the PSCell of the SCG may also be referred to as a primary cell of a master or secondary cell group (SpCell).

In some embodiments of the present application, UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. In some other embodiments of the present application, UE 101 may include a portable wireless communication device, a smart phone, a cellular telephone, a flip phone, a device having a subscriber identity module, a personal computer, a selective call receiving circuitry, or any other device that is capable of sending and receiving communication signals on a wireless network.

In some other embodiments of the present application, UE 101 may include wearable devices, such as smart watches, fitness bands, optical head-mounted displays, or the like. Moreover, UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

According to agreements of 3GPP standard documents, Release 17 work item on NR supports an efficient SCG activation or deactivation procedure in a MR-DC scenario. In an EN-DC deployment, power consumptions of a UE and a network are a big issue, due to maintaining two radio links simultaneously. In some cases, a NR UE power consumption is 3 to 4 times higher than LTE. In an EN-DC deployment, a MN provides the basic coverage. When a UE data rate requirement changes dynamically, e.g., from high to low, a SN is worth considering to be (de) activated to save energy consumptions of the network and the UE.

Generally, for a SN change procedure or a PSCell change procedure in a MR-DC scenario and/or a LTE-LTE DC scenario, a UE may successfully handover to a target SN or a target PSCell, or fail to handover to the target SN or the target PSCell, or a radio link failure (RLF) occurs shortly after a successful SN or PSCell change procedure. A PSCell change procedure refers to an intra-SN PSCell change procedure or an inter-SN PSCell change procedure. If the UE fails to handover to the target SN or PSCell, or a RLF occurs shortly after successfully completing the SN or PSCell change procedure, the UE can report “SN or PSCell change failure related information” or “RLF related information in the target SN or PSCell” to the network for a mobility robustness optimization (MRO) purpose. In addition, if the UE successfully handovers to the target SN or PSCell, there is a possibility that the successful SN or PSCell change is on the verge of a failure (e.g., the target PSCell is not stable or good enough) and the SN or PSCell change procedure is close to a failure.

Currently, there is no mechanism for a MRO purpose for a successful SN or PSCell change procedure. To resolve the abovementioned problems, embodiments of the present application enhance a MRO function in NR to provide a more robust mobility via reporting failure event(s) observed before or during or shortly after a successful SN or PSCell change procedure by introducing a successful SN or PSCell change report. It is beneficial for a UE to store or report successful SN or PSCell change related information, so that the network can optimize the SN or PSCell change related configuration (e.g., a threshold for triggering the SN or PSCell change procedure), random access channel (RACH) resource(s) for the SN or PSCell change procedure, and etc. For example, some embodiments of the present application propose solutions for introducing: condition(s) for a UE to store or set successful SN or PSCell change related information; specific contents contained in the successful SN or PSCell change related information; and a signalling procedure for reporting the successful SN or PSCell change related information. More details will be illustrated in the following text in combination with the appended drawings.

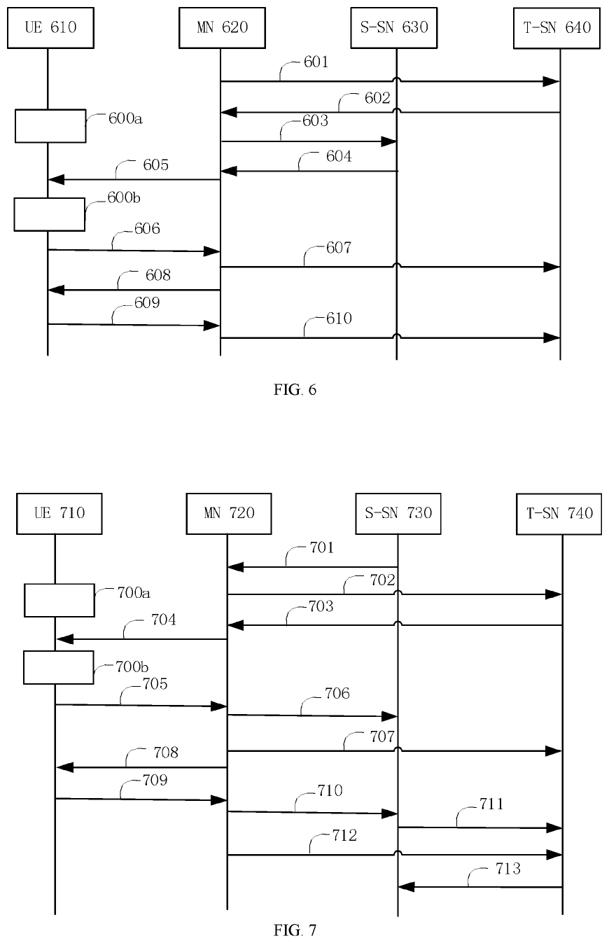

According to 3GPP standard documents, two types of SN or PSCell change procedures are supported: a MN initiated SN or PSCell change procedure; or a SN initiated SN or PSCell change procedure. The “SN or PSCell change” in this disclosure means SN or PSCell change in a LTE-LTE DC case and any MR-DC cases, which include NR-NR DC, EN-DC, NGEN-DC, and NE-DC. Details are described in FIGS. 6-8.

In the present disclosure, the term “successful SN or PSCell change related information” may be named as “information relating to a successful PSCell change procedure”, “information relating to a successful SN change procedure”, “information relating to a successful SN or PSCell change procedure”, “contents/information in a successful SN or PSCell change report” “contents/information in a successful PSCell change (SPC) report”, “SPC-Report”, or the like. In some embodiments of the present disclosure, the successful SN or PSCell change related information may be indicated as “a successful SN or PSCell change related variable”, e.g., which may be named as “VarSuccessfulPSCellChange-Report” or “VarSuccessfulSNChange-Report” or the like. It should be understood that other terms can be used to refer to the same information as the above terms, without departing from the spirit and scope of the disclosure.

FIG. 2 illustrates an exemplary flow chart of a method for storing information relating to a PSCell change procedure according to some embodiments of the present application.

The exemplary method 200 illustrated in FIG. 2 may be implemented by a UE (e.g., UE 101, UE 610, UE 710, or UE 810 as illustrated and shown in any of FIGS. 1 and 6-8). Although described with respect to a UE, it should be understood that other devices may be configured to perform a method similar to that of FIG. 2. The embodiments of FIG. 2 assume that a MN or a SN (a source SN or a target SN) may be combined in any one of LTE-LTE DC, NR-NR DC, EN-DC, NGEN-DC, NE-DC, and NR-DC scenarios.

In operation 201, a UE detects a presence of a trigger condition before or during a PSCell change procedure from a source PSCell to a target PSCell in relation to the UE, or the UE detects the presence of the trigger condition after a successful PSCell change procedure or after successfully completing the PSCell change procedure. The PSCell change procedure may be initiated by a MN or a source SN.

In operation 202, in response to detecting the presence of the trigger condition, the UE stores information relating to the PSCell change procedure. In some cases, the PSCell change procedure may also be named as the SN change procedure. In some embodiments, the UE further receives a RRC reconfiguration message from a MN. The information relating to the PSCell change procedure may be stored before, during, or after receiving the RRC reconfiguration message.

In some embodiments, the trigger condition can be configured by the network, e.g., the trigger condition can be configured in the RRC reconfiguration message or system information or other dedicated RRC message, or the trigger condition can be specified in the 3GPP specification. The UE may further receive the RRC reconfiguration message or the system information or other dedicated RRC message from the MN which includes the trigger condition.

In some embodiments, configuration for information relating to the SN/PSCell change procedure that to be stored or logged can be configured by the network, e.g., configuration for the information relating to the SN/PSCell change procedure that to be stored or logged can be configured in the RRC reconfiguration message or system information or other dedicated RRC message, or configuration for the information relating to the SN/PSCell change procedure to be stored or logged can be specified in the 3GPP specification. The UE may further receive the RRC reconfiguration message or the system information or other dedicated RRC message from the MN which includes the configuration for the information relating to the SN/PSCell change procedure to be stored or logged. Based on the configuration for the information relating to the SN/PSCell change procedure to be stored or logged, the UE may store or log the information relating to the SN/PSCell change procedure.

In some embodiments, when SN/PSCell change has been successfully completed (e.g., RACH towards the target PSCell is successful) or failed, the UE may discard the trigger condition that are configured by the network, and/or the UE may discard the configuration for information relating to the SN/PSCell change procedure that to be stored or logged.

In some embodiments, the UE may keep only a single entry for the information relating to the SN/PSCell change procedure or the SPC-Report. In some further embodiments, the UE may keep multiple entries for the information relating to the SN/PSCell change procedure or the SPC-Report.

The trigger condition of “a UE successfully completes a RACH procedure to the target PSCell or a T-SN” can be treated as a default trigger condition. As described above, information relating to the PSCell change procedure may be named as “successful SN or PSCell change related information” or the like.

In some embodiments, upon the UE performing a RACH procedure to the target PSCell or a target SN (i.e., T-SN), the UE can trigger to store RACH related information as successful SN or PSCell change related information. In some other embodiments, upon the UE successfully completing a RACH procedure to the target PSCell or a target SN (i.e., T-SN), i.e., upon the default trigger condition, the UE can trigger to set successful SN or PSCell change related information (e.g., to include RACH related information in an IE which may be named as “SPC-Report” or the like), or the UE can trigger to generate the successful SN or PSCell change related variable (e.g., to generate RACH related information in an IE which may be named as “VarSuccessfulPSCellChange-Report” or “VarSuccessfulSNChange-Report”). In some embodiments, the UE determines contents in at least one variable based on the stored or logged information relating to the SN or PSCell change procedure. In some embodiments, the UE generates the successful SN or PSCell change related variable. For instance, the UE sets successful PSCell change related information in the variable “VarSuccessfulPSCellchange-Report”.

In some embodiments, besides the abovementioned default trigger condition, there may be one or more other optional trigger condition(s). Upon the default trigger condition and other optional trigger condition(s), the UE can trigger to store or set or generate successful SN or PSCell change related information or variable. None or at least one of following optional trigger condition(s) can be considered together with the default trigger condition, as trigger condition(s) for storing or setting successful SN or PSCell change related information, or for generating the successful SN or PSCell change related variable in the UE. For instance, optional trigger condition(s) can include at least one of:
(1) A radio problem in a source SCG is detected before or during the SN or PSCell change procedure. In an embodiment, the trigger condition of the radio problem in the source SCG being detected includes at least one of:
   a) timer T310 for the source SCG is started before triggering the SN or PSCell change procedure;
   b) timer T312 for the source SCG is started before triggering the SN or PSCell change procedure;
   c) timer T310 for the source SCG is running during the SN or PSCell change procedure;
   d) timer T312 for the source SCG is running during the SN or PSCell change procedure;
   e) elapsed time for timer T310 for the source SCG exceeds a threshold, and this threshold may be configured in a RRC message (e.g., a RRCConnectionReconfiguration message) for the SN or PSCell change procedure or be predefined in the 3GPP standard specification;
   f) elapsed time for timer T312 for the source SCG exceeds a further threshold, and this further threshold may be configured in a RRC message (e.g., a RRCConnectionReconfiguration message) for the SN or PSCell change procedure or be predefined in the 3GPP standard specification; and
   g) a total number of consecutive out-of-sync indication(s) for the source SCG exceeds another threshold (e.g., N310), and this another threshold may be configured in a RRC message (e.g., a RRCConnectionReconfiguration message) for the SN or PSCell change procedure or be predefined in the 3GPP standard specification.
(2) A radio problem in a source MCG is detected before or during the SN or PSCell change procedure. In an embodiment, the trigger condition of the radio problem in the source MCG being detected includes at least one of:
   a) timer T310 for the source MCG is started before triggering the SN or PSCell change procedure;
   b) timer T312 for the source MCG is started before triggering the SN or PSCell change procedure;
   c) timer T310 for the source MCG is running during the SN or PSCell change procedure;
   d) timer T312 for the source MCG is running during the SN or PSCell change procedure;
   e) elapsed time for timer T310 for the source MCG exceeds a threshold, and this threshold may be configured in a RRC message (e.g., a RRCConnectionReconfiguration message) for the SN or PSCell change procedure or be predefined in the 3GPP standard specification;
   f) elapsed time for timer T312 for the source MCG exceeds a further threshold, and this further threshold may be configured in a RRC message (e.g., a RRCConnectionReconfiguration message) for the SN or PSCell change procedure or be predefined in the 3GPP standard specification; and
   g) a total number of consecutive out-of-sync indication(s) for the source MCG exceeds another threshold, and this another threshold may be configured in a RRC message (e.g., a RRCConnectionReconfiguration message) for the SN or PSCell change procedure or be predefined in the 3GPP standard specification.
(3) A radio problem in a target SCG is detected shortly after the successful SN or PSCell change procedure or a radio problem in a target SCG is detected shortly after successfully completing the SN or PSCell change procedure. In an embodiment, the trigger condition of the radio problem in the source MCG being detected includes at least one of:
   a) timer T310 for the target SCG is started shortly after successfully completing the SN or PSCell change procedure but a RLF does not occur in the target SCG;
   b) timer T312 for the target SCG is started shortly after successfully completing the SN or PSCell change procedure but a radio link failure (RLF) does not occur in the target SCG;
   c) elapsed time for timer T310 for the target SCG exceeds a threshold, and this threshold may be configured in a RRC message (e.g., a RRCConnectionReconfiguration message) for the SN or PSCell change procedure or be predefined in the 3GPP standard specification;
   d) elapsed time for timer T312 for the target SCG exceeds a further threshold, and this further threshold may be configured in a RRC message (e.g., a RRCConnectionReconfiguration message) for the SN or PSCell change procedure or be predefined in the 3GPP standard specification; and
   e) a total number of one or more consecutive out-of-sync indications for the target SCG exceeds another threshold, and this another threshold may be configured in a RRC message (e.g., a RRCConnectionReconfiguration message) for the SN or PSCell change procedure or be predefined in the 3GPP standard specification.
(4) A beam failure is detected in the source MCG, the source SCG, and/or the target SCG, before or during the SN/PSCell change procedure or shortly after successfully completing the SN/PSCell change procedure. For example:
   a) BFD related beam measurement(s) on the source MCG, the source SCG, and/or the target SCG are poor, e.g., Qin or Qout exceeds a threshold, and this threshold may be configured in a RRC message (e.g., a RRCConnectionReconfiguration message) for the SN or PSCell change procedure or be predefined in the 3GPP standard specification;
   b) BFR related beam measurement(s) on the source MCG, the source SCG, and/or the target SCG are poor, Qin or Qout exceeds a further threshold, and this further threshold may be configured in a RRC message (e.g., a RRCConnectionReconfiguration message) for the SN or PSCell change procedure or be predefined in the 3GPP standard specification;
   c) A total number of beam failure indication(s) exceeds a threshold, and this threshold may be configured in a RRC message (e.g., a RRCConnectionReconfiguration message) for the SN or PSCell change procedure or be predefined in the 3GPP standard specification;
   d) A counter for beam failure recovery exceeds a further threshold, and this further threshold may be configured in a RRC message (e.g., a RRCConnectionReconfiguration message) for the SN or PSCell change procedure or be predefined in the 3GPP standard specification.
(5) A RACH delay towards the target PSCell during the SN or PSCell change procedure is higher than a delay threshold. This delay threshold may be configured in a RRC message (e.g., a RRCConnectionReconfiguration message) for the SN or PSCell change procedure or be predefined in the 3GPP standard specification.
(6) Interruption time for the SN or PSCell change procedure is higher than an interruption threshold. This interruption threshold may be configured in a RRC message (e.g., a RRCConnectionReconfiguration message) for the SN or PSCell change procedure or be predefined in the 3GPP standard specification.
(7) A total number of preambles transmitted towards the target PSCell during the RACH procedure is higher than a number threshold. This number threshold may be configured in a RRC message (e.g., a RRCConnectionReconfiguration message) for the SN or PSCell change procedure or be predefined in the 3GPP standard specification.
(8) A link quality of the target PSCell is lower than a quality threshold upon successfully completing the SN or PSCell change procedure. This quality threshold may be configured in a RRC message (e.g., a RRCConnectionReconfiguration message) for the SN or PSCell change procedure or be predefined in the 3GPP standard specification. For example, the target PSCell's quality is represented by: a reference signal received power (RSRP); a reference signal received quality (RSRQ); and/or a signal to interference plus noise ratio (SINR).
(9) A link quality of the source PSCell is higher than a further quality threshold upon successfully completing the SN or PSCell change procedure. This further quality threshold may be configured in a RRC message (e.g., a RRCConnectionReconfiguration message) for the SN or PSCell change procedure or be predefined in the 3GPP standard specification. For example, the source PSCell's quality is represented by: a reference signal received power (RSRP); a reference signal received quality (RSRQ); and/or a signal to interference plus noise ratio (SINR).
(10) Radio link control (RLC) retransmission counter(s) for the source MCG exceed a counter threshold. This counter threshold may be configured in a RRC message (e.g., a RRCConnectionReconfiguration message) for the SN or PSCell change procedure or be predefined in the 3GPP standard specification. The RLC retransmission counter(s) for the source MCG can be all counters for each logical channel or the maximum counter or the average value of all the counters or at most N biggest counters for the source MCG.
(11) RLC retransmission counter(s) for the source SCG exceed a further counter threshold. This further counter threshold may be configured in a RRC message (e.g., a RRCConnectionReconfiguration message) for the SN or PSCell change procedure or be predefined in the 3GPP standard specification. The RLC retransmission counter(s) for the source SCG can be all counters for each logical channel or the maximum counter or the average value of all the counters or at most M biggest counters for the source SCG.
(12) RLC retransmission counter(s) for the target SCG exceed another counter threshold. This another counter threshold may be configured in a RRC message (e.g., a RRCConnectionReconfiguration message) for the SN or PSCell change procedure or be predefined in the 3GPP standard specification. The RLC retransmission counter(s) for the target SCG can be all counters for each logical channel or the maximum counter or the average value of all the counters or at most K biggest counters for the target SCG.
(13) Transmission power of the UE for a preamble reaches the maximum UE transmission power, or exceeds a power threshold. This power threshold may be configured in a RRC message (e.g., a RRCConnectionReconfiguration message) for the SN or PSCell change procedure or be predefined in the 3GPP standard specification.
(14) elapsed time for timer T304 for the target SCG exceeds a threshold, and this threshold may be configured in a RRC message (e.g., a RRCConnectionReconfiguration message) for the SN or PSCell change procedure or be predefined in the 3GPP standard specification.

In some embodiments, the information relating to the PSCell change procedure stored by the UE in operation 202 includes at least one of:
(1) Information relating to radio link monitoring (RLM) procedure(s) for at least one of a source MCG, and/or a source SCG, and a target SCG. In an embodiment, the information relating to the RLM procedure(s) includes at least one of:
   a) Information relating to timer(s) associated with the RLM procedure(s). For example, the information relating to the timer(s) may be configured values for the RLM related timers (validity of the RLM related timers) when the RLM related timers start and/or how long does the RLM related timers run. In an embodiment, the information relating to the timer(s) may include at least one of:
      1) configured time length for timer T310 for the source MCG, and/or the source SCG, and/or the target SCG;
      2) configured time length for timer T312 for the source MCG, and/or the source SCG, and/or the target SCG;
      3) elapsed time for timer T310 for the source MCG, and/or the source SCG, and/or the target SCG; and
      4) elapsed time for timer T312 for the source MCG, and/or the source SCG, and/or the target SCG.
   b) Measurement result(s) used for RLM procedure(s). For example, measurement results (e.g., RSRP, RSRQ, or SINR) of the source MCG, and/or the source SCG, and/or the target SCG when timer T310 and/or timer T312 starts or is running.
   c) Information relating to RLC retransmission counter(s). For example, the information relating to RLC retransmission counter(s) includes RLC retransmission counter(s) for the source MCG, and/or the source SCG, and/or the target SCG, e.g., RLC retransmission counter(s) can be: all counters for each logical channel, or the maximum counter, or the average value of all the counters, or at most N biggest counters for the source MCG, or at most M biggest counters for the source SCG, or at most K biggest counters for the target SCG.
   d) The value N310 in the source PCell, and/or the source PSCell, and/or the target PSCell.
   e) Flag(s) to indicate RLM issue(s) (e.g., including BFD and/or BFR and/or RLF) in the source PCell, and/or the source PSCell, and/or the target PSCell.
   f) consecutive out-of-sync indication(s) in the source PCell, and/or the source PSCell, and/or the target PSCell.
(2) Information relating to beam failure detection (BFD) procedure(s) for the source MCG, and/or the source SCG, and/or the target SCG. In an embodiment, the information relating to one or more BFD procedures includes at least one of:
   a) Radio link quality detection indicator(s), e.g., Qin and Qout indications as specified in 3GPP standard document TS38.133;
   b) Radio link quality detection counter(s). For example, the information relating to BFD procedure(s) may be counter(s) for the source MCG, and/or the source SCG, and/or the target SCG, e.g., a counter of beam failure indication, and/or a counter of beam failure recovery.
   c) Measurement result(s) used in the BFD procedure(s), e.g., measurement results (e.g., RSRP, RSRQ, or SINR) of the source MCG, and/or the source SCG, and/or target SCG when a BFD procedure happens in the source MCG, the source SCG, and/or target SCG.
   d) At least one indication to indicate whether serving beam(s) are failed before the BFD procedure triggered in the source MCG, and/or the source SCG, and/or the target SCG.
(3) Information relating to the SN or PSCell change procedure. In an embodiment, the information relating to the SN or PSCell change procedure includes at least one of:
   a) Information relating to SN or PSCell change related timer(s) (e.g., timer T304) for the target SCG. For instance, the information includes configured value(s) for timer T304 (validity of timer T304) and how long does timer T304 run. In an embodiment, the information relating to SN or PSCell change related timer(s) may include at least one of: configured time length for timer T304 for the target SCG; and elapsed time for timer T304 for the target SCG.
   b) Measurement results of the source MCG, and/or the source SCG, and/or the target SCG, when the SN or PSCell change procedure is triggered, when the SN or PSCell change procedure is successfully completed, or when the SN or PSCell change procedure is finished.
   c) Time information regarding when the measurement results associated with the PSCell change procedure are collected, e.g., a measurement period indication, measurement results are collected at the time of triggering the SN or PSCell change procedure, at the time of successfully completing the SN or PSCell change procedure or at the end of the SN or PSCell change procedure.
   d) RACH related information, e.g., information for RACH procedure towards the target PSCell. For example, RACH related information includes RA-purpose and time or frequency information for RACH, e.g., the details can refer to RA-InformationCommon IE specified in TS38.331.
(4) A RACH delay towards the target PSCell.
(5) Interruption time for the SN or PSCell change procedure.
(6) A total number of preamble(s) transmitted towards the target PSCell.
(7) Transmission power of the UE for a RACH procedure towards the target PSCell.
(8) Location information of the UE.

In some embodiments, the UE discards the logged or stored successful SN/PSCell change related information or variable in the following cases:
(1) reporting successful SN/PSCell change related information or variable to the network is initiated by the UE;
(2) successful SN/PSCell change related information or variable is successfully reported by the UE;
(3) specific time (e.g., 48 hours) has passed since successful SN/PSCell change procedure or successful SN/PSCell change related information or variable is successfully reported;
(4) upon power off or detach is initiated.

In some embodiments, the UE further transmits an indication to a network device to indicate an availability of the information relating to the PSCell change procedure. The indication may be included in a RRC reconfiguration complete message. The indication may be set as true, if the information relating to the PSCell change procedure is available.

In some other embodiments, the UE further receives a message from a network device for requesting the information relating to the PSCell change procedure. For instance, the received message includes an indication that is set as true to request the information relating to the PSCell change procedure. In some embodiments, the received message is a UE information request message and/or a downlink information transfer MR-DC message. Specific examples are described in FIGS. 6-8 as follows.

In some embodiments, after receiving the message for requesting the information relating to the PSCell change procedure, the UE further transmits, to the network device, a message which includes the information relating to the PSCell change procedure. For instance, the transmitted message is a UE information response message and/or an uplink information transfer MRDC message. The transmitted message may include variable(s) that include the information relating to the PSCell change procedure, e.g., successful SN/PSCell change related variable “VarSuccessfulPSCellchange-Report”. Specific examples are described in FIGS. 6-8 as follows.

Details described in the embodiments as illustrated and shown in FIGS. 1 and 3-9, especially, contents regarding information relating to a PSCell change procedure and a trigger condition for storing or logging or setting the information relating to a PSCell change procedure, are applicable for the embodiments as illustrated and shown in FIG. 2. Moreover, details described in the embodiments of FIG. 2 are applicable for all the embodiments of FIGS. 1 and 3-9.

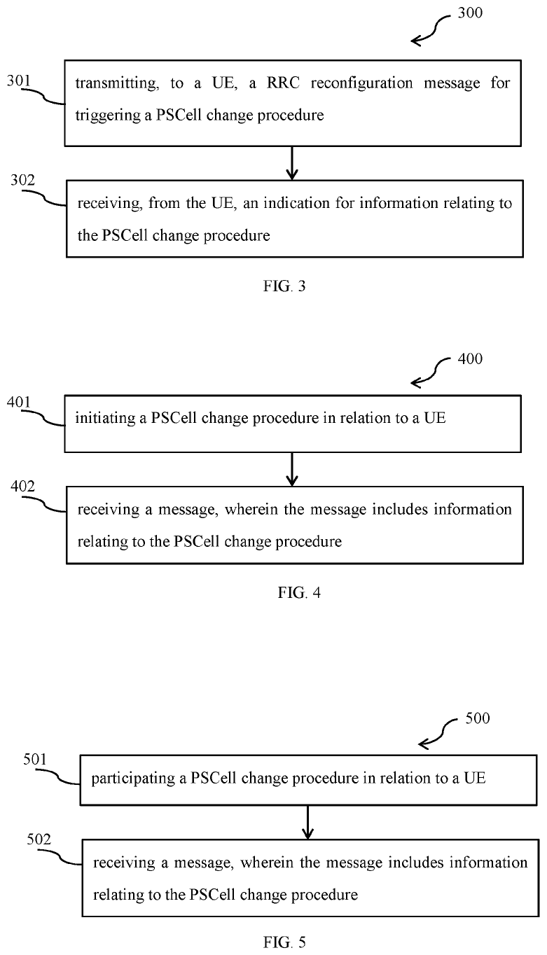

FIG. 3 illustrates an exemplary flow chart of a method for receiving an indication for information relating to a PSCell change procedure according to some embodiments of the present application.

The method illustrated in FIG. 3 may be implemented by a RAN node (e.g., MN 102, MN 620, MN 720, or MN 820 as shown and illustrated in FIGS. 1 and 6-8, respectively). Although described with respect to a RAN node, e.g., a SN, it should be understood that other devices may be configured to perform a method similar to that of FIG. 3.

In the exemplary method 300 as shown in FIG. 3, in operation 301, a MN (e.g., MN 102 as illustrated and shown in FIG. 1) transmits, to a UE (e.g., UE 101 as illustrated and shown in FIG. 1), a RRC reconfiguration message for triggering a SN/PSCell change procedure. In operation 302, the MN receives, from the UE, an indication for information relating to the PSCell change procedure.

In some embodiments, the indication is included in a RRC reconfiguration complete message. In some embodiments, the indication is used for indicating an availability of the information relating to the PSCell change procedure. For example, the indication may be set as true, if the information relating to the PSCell change procedure is available or the information relating to the PSCell change procedure is stored or logged or set by the UE.

The information relating to the PSCell change procedure stored or logged or set by the UE in operation 202 as described in the embodiments of FIG. 2 above may be applicable for the information relating to the PSCell change procedure received by the MN from the UE in the embodiments of FIG. 3.

In some embodiments, the MN further transmits, to the UE, a message for requesting the information relating to the PSCell change procedure. The message may include an indication, which may be set as true to request the information relating to the PSCell change procedure. For example, the transmitted message is a UE information request message.

In some embodiments, the MN further receives a message, which includes the information relating to the PSCell change procedure, from the UE. For example, the received message may be a UE information response message and/or an uplink information transfer MRDC message. In an embodiment, the message includes variable(s) that include the information relating to the PSCell change procedure, e.g., successful SN or PSCell change related variable “VarSuccessfulPSCellchange-Report”.

In some embodiments, for a MN or SN initiated PSCell change procedure, the MN further analyzes the information relating to the PSCell change procedure and optimizes the information relating to the PSCell change procedure.

In some embodiments, the MN further transmits, to a target SN, an indication to indicate an availability of information relating to the PSCell change procedure.

In some embodiments, for a SN initiated PSCell change procedure, the MN may receive the information relating to the PSCell change procedure from a source SN and/or a target SN.

In some embodiments, the MN transmits a further message to at least one of a source SN, a target SN, an access and mobility management function (AMF), and a mobility management entity (MME). The further message includes the information relating to the PSCell change procedure. For instance, the further message transmitted by the MN may be at least one of:
(1) a RRC transfer message;
(2) a Xn interface message;
(3) a X2 interface message;
(4) a S1 interface message, for example, when there is no direct Xn or X2 interface between two RAN nodes;
(5) a new generation (NG) interface message;
(6) an uplink RAN configuration transfer message, for example, which is transmitted to an AMF; and
(7) an eNB configuration transfer message, for example, which is transmitted to an MME.

In some embodiments, to enable the source SN to identify the association between the UE and information relating to the PSCell change procedure (e.g., the successful SN/PSCell change related information included in the SPC-Report) especially for the case that UE context (e.g., source PSCell related UE context) is released in the source SN, the further message transmitted by the MN to the source SN includes at least one of:
(1) A Xn application protocol (XnAP) identifier (ID) of the UE allocated at the source SN.
(2) A X2 application protocol (X2AP) ID of the UE allocated at the source SN.
(3) A XnAP ID of the UE allocated at the target SN.
(4) A X2AP ID of the UE allocated at the target SN.
(5) A XnAP ID of the UE allocated at the MN.
(6) A X2AP ID of the UE allocated at the MN.
(7) PSCell change information. This is information related to the PSCell change, in order to enable later analysis of the conditions that led to a successful PSCell change. At first, this information is provided by the source SN and/or the MN during SN addition or preparation procedure, if the PSCell change information IE is provided in the SN addition request message, the target SN shall, if supported, store this information.
(8) A cell radio network temporary identifier (C-RNTI) of a source PSCell of the UE.
(9) An ID of source PSCell. For example, the ID of source PSCell may be a physical cell identifier (PCI) of the source PSCell together with frequency information; and/or a cell global identifier (CGI) of the source PSCell.
(10) A context of the UE.

For example, in some embodiments, if there is no direct Xn or X2 interface between two RAN nodes (the MN, the source SN, and/or the target SN), information relating to the PSCell change procedure (e.g., the SPC-Report) can be transferred via a S1 interface or a NG interface, e.g., a MME (if the involved RAN node(s) is connected to the MME) or an AMF (if the involved RAN node(s) is connected to the AMF). For example, if the involved RAN node(s) is connected to the AMF, an existing message (e.g., Uplink RAN Configuration Transfer message) or a new message can be used to transfer the SPC-Report (e.g., SPC-Report can be regarded as a container included in the Uplink RAN Configuration Transfer message) from a RAN node to the AMF, and an existing message (e.g., Downlink RAN Configuration Transfer message) or a new message can be used to transfer the SPC-Report (e.g., SPC-Report can be regarded as a container included in the Downlink RAN Configuration Transfer message) from the AMF to a RAN node.

In some further embodiments, if the involved RAN node(s) is connected to the MME, an existing message (e.g., eNB CONFIGURATION TRANSFER message) or a new message can be used to transfer the SPC-Report (e.g., SPC-Report can be regarded as a container included in the eNB CONFIGURATION TRANSFER message) from a RAN node to the MME, and an existing message (e.g., MME CONFIGURATION TRANSFER message) or a new message can be used to transfer the SPC-Report (e.g., SPC-Report can be regarded as a container included in the Downlink RAN Configuration Transfer message) from the MME to a RAN node.

In some other embodiments, if there is no direct Xn or X2 interface between a MN and a T-SN, and if both the MN and the T-SN are connected to an AMF, the MN can transfer the SPC-Report to the AMF via an existing message (e.g., Uplink RAN Configuration Transfer message) or a new message, and then, the AMF can transfer the SPC-Report to the T-SN via an existing message (e.g., Downlink RAN Configuration Transfer message) or a new message. Specific examples are described in FIGS. 6-8 as follows.

Details described in the embodiments as illustrated and shown in FIGS. 1, 2, and 4-9, especially, contents regarding information relating to a PSCell change procedure and a trigger condition for storing or logging or setting the information relating to a PSCell change procedure, are applicable for the embodiments as illustrated and shown in FIG. 3. Moreover, details described in the embodiments of FIG. 3 are applicable for all the embodiments of FIGS. 1, 2, and 4-9.

FIG. 4 illustrates an exemplary flow chart of a method for receiving information relating to a PSCell change procedure according to some embodiments of the present application.

The method illustrated in FIG. 4 may be implemented by a RAN node (e.g., SN 103, S-SN 630, S-SN 730, or S-SN 830 as shown and illustrated in FIGS. 1 and 6-8, respectively). Although described with respect to a RAN node, e.g., a source SN which may be marked as S-SN, it should be understood that other devices may be configured to perform a method similar to that of FIG. 4.

In the exemplary method 400 as shown in FIG. 4, in operation 401, a source SN (e.g., SN 103 as illustrated and shown in FIG. 1) initiates a PSCell change procedure in relation to a UE. In operation 402, the source SN receives a message which includes information relating to the PSCell change procedure. The information relating to the PSCell change procedure stored by the UE in operation 202 of the embodiments of FIG. 2 as described above may be applicable for the information relating to the PSCell change procedure received by the source SN in operation 402 of the embodiments of FIG. 4.

For example, the message in operation 402 may be received from a MN (e.g., MN 620 as illustrated and shown in FIG. 6) or a target SN (e.g., T-SN 640 as illustrated and shown in FIG. 6). In an embodiment, to enable the source SN to identify the association between the UE and information relating to the PSCell change procedure (e.g., the successful SN/PSCell change related information included in the SPC-Report) especially for the case that UE context (e.g., source PSCell related UE context) is released in the source SN, the message received from the MN includes at least one of:
(1) a XnAP ID of the UE allocated at the source SN;
(2) a X2AP ID of the UE allocated at the source SN;
(3) a XnAP ID of the UE allocated at the target SN;
(4) a X2AP ID of the UE allocated at the target SN;
(5) a XnAP ID of the UE allocated at the MN;
(6) a X2AP ID of the UE allocated at the MN;
(7) PSCell change information. This is information related to the PSCell change, in order to enable later analysis of the conditions that led to a successful PSCell change. At first, this information is provided by the source SN and/or the MN during SN addition or preparation procedure, if the PSCell change information IE is provided in the SN addition request message, the target SN shall, if supported, store this information.
(8) a C-RNTI of a source PSCell of the UE;
(9) a PCI of the source PSCell together with frequency information;
(10) a CGI of the source PSCell; and
(11) a context of the UE.

In some embodiments, the source SN transmits a message including the information relating to the PSCell change procedure to at least one of the target SN, an AMF, and a MME. The message received in operation 402 and/or the further message transmitted by the source SN may be at least one of:
(1) a RRC transfer message;
(2) a Xn interface message;
(3) a X2 interface message;
(4) a S1 interface message;
(5) a NG interface message;
(6) an uplink RAN configuration transfer message, e.g., transmitted to an AMF;
(7) an downlink RAN configuration transfer message, e.g., transmitted to an AMF; and
(8) an eNB configuration transfer message, e.g., transmitted to a MME.

In some embodiments, the source SN receives, from a MN, an indication to indicate an availability of the information relating to the PSCell change procedure. In some embodiments, for a SN initiated PSCell change procedure, the source SN analyzes the information relating to the PSCell change procedure, and optimizes the information relating to the PSCell change procedure.

Details described in the embodiments as illustrated and shown in FIGS. 1-3 and 5-9, especially, contents regarding information relating to a PSCell change procedure and a trigger condition for storing or logging or setting the information relating to a PSCell change procedure, are applicable for the embodiments as illustrated and shown in FIG. 4. Moreover, details described in the embodiments of FIG. 4 are applicable for all the embodiments of FIGS. 1-3 and 5-9.

FIG. 5 illustrates a further exemplary flow chart of a method for receiving information relating to a PSCell change procedure according to some embodiments of the present application.

The method illustrated in FIG. 5 may be implemented by a RAN node (e.g., SN 103, T-SN 640, T-SN 740, or T-SN 840 as shown and illustrated in FIGS. 1 and 6-8, respectively). Although described with respect to a RAN node, e.g., a target SN which may be marked as T-SN, it should be understood that other devices may be configured to perform a method similar to that of FIG. 5.

In the exemplary method 500 as shown in FIG. 5, in operation 501, a target SN (e.g., SN 103 as illustrated and shown in FIG. 1) participates in a PSCell change procedure. For example, the target SN prepares and allocates resource(s) for the PSCell change procedure. In operation 502, the target SN receives a message which includes information relating to the PSCell change procedure. The information relating to the PSCell change procedure stored or logged or set by the UE in operation 202 of the embodiments of FIG. 2 as described above may be applicable for the information relating to the PSCell change procedure received by the target SN in operation 502 of the embodiments of FIG. 5.

In some embodiments, the message in operation 502 may be received from at least one of: a MN; a source SN; a UE; an AMF or a MME if there is no direct Xn/X2 interface between two RAN nodes;. In some embodiments, the message received in operation 502 may be: a RRC transfer message; a Xn interface message; a X2 interface message; a S1 interface message; a NG interface message; a uplink information transfer MRDC message; an uplink RAN configuration transfer message (e.g., transmitted from a RAN node to an AMF); an downlink RAN configuration transfer message (e.g., transmitted from an AMF to a RAN node); and/or an eNB configuration transfer message (e.g., transmitted from a RAN node to an MME); and a MME CONFIGURATION TRANSFER message (e.g., transmitted from an MME to a RAN node).

In some embodiments, the target SN further transmits a message that includes the information relating to the PSCell change procedure. For example, the message may be transmitted to a MN, a source SN, an AMF, or a MME. In some embodiments, the message transmitted by the target SN may be: a RRC transfer message; a Xn interface message; a X2 interface message; a S1 interface message; a NG interface message; a uplink information transfer MRDC message; an uplink RAN configuration transfer message (e.g., transmitted from a RAN node to an AMF); an downlink RAN configuration transfer message (e.g., transmitted from an AMF to a RAN node); and/or an eNB configuration transfer message (e.g., transmitted from a RAN node to an MME); and a MME CONFIGURATION TRANSFER (e.g., transmitted from an MME to a RAN node).

In some embodiments, the message received in operation 502 and/or the message transmitted by the target SN may include at least one of:
(1) a XnAP ID of the UE allocated at the source SN;
(2) a X2AP ID of the UE allocated at the source SN;
(3) a XnAP ID of the UE allocated at the target SN;
(4) a X2AP ID of the UE allocated at the target SN;
(5) a XnAP ID of the UE allocated at the MN;
(6) a X2AP ID of the UE allocated at the MN;
(7) PSCell change information. This is information related to the PSCell change, in order to enable later analysis of the conditions that led to a successful PSCell change. At first, this information is provided by the source SN and/or the MN during SN addition or preparation procedure, if the PSCell change information IE is provided in the SN addition request message, the target SN shall, if supported, store this information.
(8) a C-RNTI of a source PSCell of the UE;
(9) a PCI of the source PSCell together with frequency information;
(10) a CGI of the source PSCell; and
(11) a context of the UE.

In some embodiments, the target SN further analyzes the information relating to the PSCell change procedure and optimizes the information relating to the PSCell change procedure.

In some embodiments, the target SN further receives, from a MN, an indication to indicate an availability of the information relating to the PSCell change procedure. For example, the indication is included in a SN reconfiguration complete message. The indication may be set as true, if the information relating to the PSCell change procedure is available.

In some embodiments, the target SN further receives, from a UE, an indication to indicate an availability of the information relating to the PSCell change procedure. For example, the indication is included in a RRC reconfiguration complete message. The indication may be set as true, if the information relating to the PSCell change procedure is available.

In some embodiments, after receiving the indication to indicate an availability of the information relating to the PSCell change procedure, the target SN transmits, to a UE, a further message for requesting the information relating to the PSCell change procedure. The further message transmitted by the target SN may include a further indication, which can be set as true to request the information relating to the PSCell change procedure. For example, the target SN transmits a downlink information transfer MRDC message which includes the further indication. Specific examples are described in FIGS. 6-8 as follows.

Details described in the embodiments as illustrated and shown in FIGS. 1-4 and 6-9, especially, contents regarding information relating to a PSCell change procedure and a trigger condition for storing or logging or setting the information relating to a PSCell change procedure, are applicable for the embodiments as illustrated and shown in FIG. 5. Moreover, details described in the embodiments of FIG. 5 are applicable for all the embodiments of FIGS. 1-4 and 6-9.

FIG. 6 illustrates an exemplary flow chart of a MN initiated PSCell change procedure according to some embodiments of the present application. The embodiments of FIG. 6 show a signalling procedure for reporting successful SN or PSCell change related information (e.g., SPC-Report) for a MN initiated SN or PSCell change procedure. Although the embodiments of FIG. 6 shows signalling for a MN initiated inter-SN PSCell change procedure, the embodiments of FIG. 6 may also be applied to a MN initiated intra-SN PSCell change procedure, i.e., the source PSCell and the target PSCell belong to the same SN (i.e., S-SN 630 and T-SN 640 as shown in FIG. 6 is the same node).

In the embodiments of FIG. 6, for a MN initiated inter-SN PSCell change procedure, in step 601, MN 620 may send a SN addition request message to T-SN 640. In step 602, T-SN 640 may send a SN addition request ACK message to MN 620. In step 603, MN 620 may send a SN release request message to S-SN 630. In step 604, S-SN 630 may send a SN release request ACK message to MN 620. In step 605, MN 620 may send a RRC reconfiguration message for triggering a PSCell change to UE 610.

In accordance with the embodiments of FIG. 2, in the embodiments of FIG. 6, UE 610 may store or log or set or set successful SN/PSCell change related information before or during the MN initiated inter-SN PSCell change procedure when the trigger condition is satisfied, or after successfully completing the MN initiated inter-SN PSCell change procedure, e.g., when RACH towards the target PSCell is successful. As shown in steps 600a and 600b of FIG. 6, UE 610 can store or log or set the successful SN/PSCell change related information (e.g., information relating to the PSCell change procedure stored by the UE or SPC-Report) or generate successful SN/PSCell change related variable (e.g., VarSuccessfulPSCellChange-Report or VarSuccessfulSNChange-Report) according to the embodiments of FIGS. 2-5.

Then, in step 606 of FIG. 6, UE 610 may send one indication for the availability of information relating to the PSCell change procedure or SPC-Report (e.g., an IE successfulPSCellchange-InfoAvailable which can be set to “true”) to MN 620 via a RRC Reconfiguration Complete message. In step 607 of FIG. 6, MN 620 may send a SN reconfiguration complete message to T-SN 640; and optionally, the indication for the availability of information relating to the PSCell change procedure or SPC-Report can be included in the SN reconfiguration complete message.

In step 608 of FIG. 6, MN 620 may request UE 610 to report successful SN or PSCell change related information (e.g., information relating to the PSCell change procedure stored by the UE or SPC-Report). For example, MN 620 can send one message that includes an IE (e.g., SPC-ReportReq which is set to “true”) to UE 610. The message can be an existing message (e.g., (UEInformationRequest message) or a new defined message having the same function.

In step 609 of FIG. 6, after receiving the request from MN 620, UE 610 may report the successful SN or PSCell change related information (e.g., information relating to the PSCell change procedure stored by the UE or SPC-Report) to MN 620 via a UEInformationResponse message, a UILInformation TransferMRDC′ message, or a new defined message having the same function.

After receiving the successful SN or PSCell change related information (e.g., information relating to the PSCell change procedure stored by the UE or SPC-Report) from UE 610, MN 620 may make an analysis on the successful SN or PSCell change related information. Based on the analysis, MN 620 may optimize SN or PSCell change related configuration(s) (e.g., a threshold for triggering SN/PSCell change). Also, in step 610 of FIG. 6, MN 620 can transfer the successful SN or PSCell change related information (e.g., information relating to the PSCell change procedure stored by the UE or SPC-Report) to T-SN 640 via an existing Xn or X2 message (e.g., RRC Transfer message) or a new defined Xn or X2 message. Then, T-SN 640 can decide whether RACH configuration(s) for the target PSCell needs an optimization based on the successful SN or PSCell change related information (e.g., SPC-Report). If needed, T-SN 640 can optimize the RACH configuration(s) for the target PSCell.

Details described in the embodiments as illustrated and shown in FIGS. 1-5 and 7-9, especially, contents regarding successful SN or PSCell change related information and a trigger condition for storing or logging or setting the successful SN or PSCell change related information, are applicable for the embodiments as illustrated and shown in FIG. 6. Moreover, details described in the embodiments of FIG. 6 are applicable for all the embodiments of FIGS. 1-5 and 7-9.

FIG. 7 illustrates an exemplary flow chart of a SN initiated PSCell change procedure according to some embodiments of the present application. The embodiments of FIG. 7 show a signalling procedure for reporting successful SN or PSCell change related information (e.g., information relating to the PSCell change procedure stored by the UE or SPC-Report) for a SN initiated SN or PSCell change procedure. Although the embodiments of FIG. 7 shows signalling for a SN initiated inter-SN PSCell change procedure, the embodiments of FIG. 7 may also be applied to a SN initiated intra-SN PSCell change procedure, i.e., the source PSCell and the target PSCell belong to the same SN (i.e., S-SN 730 and T-SN 740 as shown in FIG. 7 is the same node).

In the embodiments of FIG. 7, for a SN initiated inter-SN PSCell change procedure, in step 701, S-SN 730 may send a SN change required message to MN 720. In step 702, MN 720 may send a SN addition request message to T-SN 740. In step 703, T-SN 740 may send a SN addition request ACK message to MN 720. In step 704, MN 720 may send a RRC reconfiguration message for triggering a PSCell change to UE 710.

In accordance with the embodiments of FIG. 2, in the embodiments of FIG. 7, UE 710 may store/log or set successful SN or PSCell change related information before or during the SN initiated inter-SN PSCell change procedure when the trigger condition is satisfied, or after successfully completing the SN initiated inter-SN PSCell change procedure, e.g., when RACH towards the target PSCell is successful. As shown in steps 700a and 700b of FIG. 7, UE 710 can store or log or set the successful SN or PSCell change related information (e.g., information relating to the PSCell change procedure stored by the UE or SPC-Report) or generate the successful SN or PSCell change related variable (e.g., VarSuccessfulPSCellChange-Report or VarSuccessfulSNChange-Report) according to the embodiments of FIGS. 2-5.

Then, in step 705 of FIG. 7, UE 710 can send one indication for the availability of the successful SN or PSCell change related information or SPC-Report (e.g., the IE successfulPSCellchange-InfoAvailable which can be set to “true”) to MN 720 via a RRC Reconfiguration Complete message. In step 706 of FIG. 7, MN 720 can send a SN change confirm message to S-SN 730. In step 707 of FIG. 7, MN 720 can send a SN reconfiguration complete message to T-SN 740; and optionally, the indication for the availability of information relating to the PSCell change procedure or SPC-Report can be included in the SN reconfiguration complete message.

In step 708 of FIG. 7, MN 720 can request the UE to report the successful SN or PSCell change related information (e.g., information relating to the PSCell change procedure stored by the UE or SPC-Report). For example, MN 720 can send one message that includes an IE (e.g., SPC-ReportReq which is set to “true”) to the UE. The message can be the existing message (i.e., UE Information Request message) or a new defined message.

In step 709 of FIG. 7, after receiving the request, UE 710 can report the successful SN or PSCell change related information (e.g., information relating to the PSCell change procedure stored by the UE or SPC-Report) to MN 720 via a UEInformationResponse message, a ULInformationTransferMRDC message, or a new defined message. After step 709 of FIG. 7, one of following two solutions may be performed in different embodiments, i.e., “Solution A” including steps 710 to 711 and “Solution B” including steps 712 and 713.

### Solution A

In Solution A, in step 710 of FIG. 7, MN 720 can send the successful SN or PSCell change related information (e.g., information relating to the PSCell change procedure stored by the UE or SPC-Report) from UE 710 to S-SN 730 via an existing Xn or X2 message (e.g., a RRC Transfer message) or a new defined Xn or X2 message. Then, S-SN 730 makes an analysis, and may optimize SN or PSCell change related configuration(s) (e.g., a threshold for triggering SN/PSCell change). Optionally, to enable S-SN 730 to identify the association between UE 710 and the successful SN or PSCell change related information (e.g., information relating to the PSCell change procedure stored by the UE or SPC-Report) especially for the case that a context of UE 710 (e.g., source PSCell related UE context) is released in S-SN 730, this Xn or X2 message from the MN to the S-SN can contain at least:
(1) XnAP ID of UE 710 allocated at S-SN 730; XnAP ID of UE 710 allocated at T-SN 740; and/or XnAP ID of UE 710 allocated at MN 720.
(2) X2AP ID of UE 710 allocated at S-SN 730; X2AP ID of UE 710 allocated at T-SN 740; and/or X2AP ID of UE 710 allocated at MN 720.
(3) PSCell change information of UE 710. This is information related to the PSCell change, in order to enable a later analysis of the conditions that led to a successful PSCell change. At first, this information is provided by the source SN and/or the MN during SN addition or preparation procedure, if the PSCell change information IE is provided in the SN addition request message, the target SN shall, if supported, store this information.
(4) Source PSCell C-RNTI and/or source PSCell ID (e.g., PCI together with frequency information, and/or CGI).
(5) A context of UE 710.

Optionally, in step 711 of FIG. 7, after receiving the successful SN or PSCell change related information (e.g., information relating to the PSCell change procedure stored by the UE or the SPC-Report) from MN 720, S-SN 730 can transfer the successful SN or PSCell change related information (e.g., information relating to the PSCell change procedure stored by the UE or SPC-Report) to T-SN 740 via an existing Xn or X2 message (e.g., RRC Transfer message) or a new defined Xn or X2 message if there is a direct interface between S-SN 730 and T-SN 740, or via a S1 message or a NG message if there is no direct interface between S-SN 730 and T-SN 740. Then, T-SN 740 can decide whether RACH configuration(s) for the target PSCell needs an optimization based on the successful SN or PSCell change related information (e.g., information relating to the PSCell change procedure stored by the UE or SPC-Report). If needed, T-SN 740 can optimize the RACH configuration(s) for the target PSCell.

Optionally, MN 720 can transfer the successful SN or PSCell change related information (e.g., information relating to the PSCell change procedure stored by the UE or SPC-Report) to T-SN 740 via an existing Xn or X2 message (e.g., RRC Transfer message) or a new defined Xn or X2 message. Then, T-SN 740 can decide whether RACH configuration(s) for the target PSCell needs an optimization based on the successful SN or PSCell change related information (e.g., information relating to the PSCell change procedure stored by the UE or SPC-Report). If needed, T-SN 740 can optimize the RACH configuration(s) for the target PSCell.

### Solution B

In Solution B, in step 712 of FIG. 7,MN 720 can send the successful SN or PSCell change related information (e.g., information relating to the PSCell change procedure stored by the UE or SPC-Report) from UE 710 to T-SN 740 via an existing Xn or X2 message (e.g., RRC Transfer message) or a new defined Xn or X2 message. Then, T-SN 740 makes an analysis to decide whether RACH configuration(s) for the target PSCell needs an optimization based on the successful SN or PSCell change related information (e.g., SPC-Report). If needed, T-SN 740 can optimize the RACH configuration(s) for the target PSCell. MN 720 may need to indicate T-SN 740 to transfer the successful SN or PSCell change related information (e.g., information relating to the PSCell change procedure stored by the UE or SPC-Report) to S-SN 730, so an indication for indicating T-SN 740 to transfer the successful SN or PSCell change related information (e.g., information relating to the PSCell change procedure stored by the UE or SPC-Report) to S-SN 730 can be included in this Xn or X2 message. Optionally, to enable S-SN 730 to identify the association between UE 710 and the successful SN or PSCell change related information (e.g., information relating to the PSCell change procedure stored by the UE or SPC-Report) especially for the case that a context of UE 710 (e.g., source PSCell related UE context) is released in S-SN 730, this Xn or X2 message from MN 720 to T-SN 740 can contain at least one of:
(1) XnAP ID of UE 710 allocated at S-SN 730; XnAP ID of UE 710 allocated at T-SN 740; and/or XnAP ID of UE 710 allocated at MN 720.
(2) X2AP ID of UE 710 allocated at S-SN 730; X2AP ID of UE 710 allocated at T-SN 740; and/or X2AP ID of UE 710 allocated at MN 720.
(3) PSCell change information of UE 710. This is information related to the PSCell change, in order to enable a later analysis of the conditions that led to a successful PSCell change. At first, this information is provided by the source SN and/or the MN during SN addition or preparation procedure, if the PSCell change information IE is provided in the SN addition request message, the target SN shall, if supported, store this information.
(4) Source PSCell C-RNTI and/or source PSCell ID (e.g., PCI together with frequency information, and/or CGI).
(5) A context of UE 710.

In step 713 of FIG. 7, after receiving the successful SN or PSCell change related information (e.g., information relating to the PSCell change procedure stored by the UE or SPC-Report) from MN 720, T-SN 740 can transfer the successful SN or PSCell change related information (e.g., information relating to the PSCell change procedure stored by the UE or SPC-Report) to S-SN 730 via an existing Xn or X2 message (e.g., RRC Transfer message) or a new defined Xn or X2 message if there is a direct interface, or via a S1 or NG message if there is no direct interface. Then, S-SN 730 and may optimize SN or PSCell change related configuration(s) (e.g., a threshold for triggering SN/PSCell change). Optionally, to enable T-SN 740 and/or S-SN 730 to identify the association between UE 710 and the successful SN or PSCell change related information (e.g., information relating to the PSCell change procedure stored by the UE or SPC-Report) especially for the case that a context of UE 710 (e.g., source PSCell related UE context) is released in S-SN 730, this Xn or X2 message from T-SN 740 to the S-SN 730 can contain at least one of:
(1) XnAP ID of UE 710 allocated at S-SN 730; XnAP ID of UE 710 allocated at T-SN 740; and/or XnAP ID of UE 710 allocated at MN 720.
(2) X2AP ID of UE 710 allocated at S-SN 730; X2AP ID of UE 710 allocated at T-SN 740; and/or X2AP ID of UE 710 allocated at MN 720.
(3) PSCell change information of UE 710. This is information related to the PSCell change, in order to enable a later analysis of the conditions that led to a successful PSCell change procedure. At first, this information provided by S-SN 730 and/or MN 720, if the PSCell change information IE is provided in a SN addition request message, T-SN 740 shall, if supported, store this information.
(4) Source PSCell C-RNTI and/or source PSCell ID (e.g., PCI together with frequency information, and/or CGI)
(5) A context of UE 710.

Details described in the embodiments as illustrated and shown in FIGS. 1-6, 8, and 9, especially, contents regarding successful SN or PSCell change related information and a trigger condition for storing or logging or setting the successful SN or PSCell change related information, are applicable for the embodiments as illustrated and shown in FIG. 7. Moreover, details described in the embodiments of FIG. 7 are applicable for all the embodiments of FIGS. 1-6, 8, and 9.

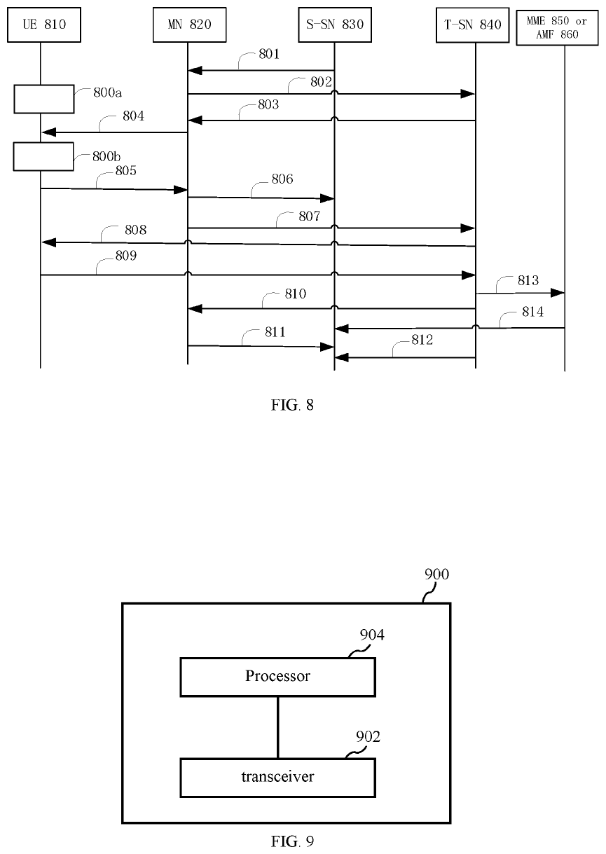

FIG. 8 illustrates a further exemplary flow chart of a SN initiated PSCell change procedure according to some embodiments of the present application. The embodiments of FIG. 8 show a signalling procedure for reporting successful SN or PSCell change related information (e.g., information relating to the PSCell change procedure stored by the UE or SPC-Report) for a SN initiated SN or PSCell change procedure. Although the embodiments of FIG. 8 shows signalling for a SN initiated inter-SN PSCell change procedure, the embodiments of FIG. 8 may also be applied to a SN initiated intra-SN PSCell change procedure, i.e., the source PSCell and the target PSCell belong to the same SN (i.e., S-SN 830 and T-SN 840 as shown in FIG. 8 is the same node). The embodiments of FIG. 8 can work when SRB3 is available in T-SN 840 and UE 810 is configured with SRB3 to communicate with the T-SN 840.

In the embodiments of FIG. 8, for a SN initiated inter-SN PSCell change procedure, in step 801, S-SN 830 may send a SN change required message to MN 820. In step 802, MN 820 may send a SN addition request message to T-SN 840. In step 803, T-SN 840 may send a SN addition request ACK message to MN 820. In step 804, MN 820 may send a RRC reconfiguration message for triggering PSCell change to UE810.

In accordance with the embodiments of FIG. 2, in the embodiments of FIG. 8, UE 810 may store or log or set successful SN or PSCell change related information before or during the SN initiated inter-SN PSCell change procedure when trigger condition is satisfied, or after successfully completing the MN initiated inter-SN PSCell change procedure, e.g., when RACH towards the target PSCell is successful. As shown in steps 800a and 800b of FIG. 8, UE 810 can store or log or set the successful SN or PSCell change related information (e.g., information relating to the PSCell change procedure stored by the UE or SPC-Report) or generate the successful SN or PSCell change related variable (e.g., VarSuccessfulPSCellChange-Report or VarSuccessfulSNChange-Report) according to the embodiments of FIGS. 2-5.

Then, in step 805 of FIG. 8, UE 810 can send one indication for the availability of the successful SN or PSCell change related information or SPC-Report (e.g., the IE successfulPSCellchange-InfoAvailable which can be set to “true”) to MN 820 via a RRC Reconfiguration Complete message. In step 806 of FIG. 8, MN 820 can send a SN change confirm message to S-SN 830.

In step 807 of FIG. 8, MN 820 can send a SN reconfiguration complete message to T-SN 840. Since MN 820 receives the SN change required message from S-SN 830 in step 801, MN 820 knows that it is a S-SN initiated SN or PSCell change procedure, MN 820 can transfer, to T-SN 840, an indication for the availability of the successful SN or PSCell change related information, or an indication for the availability of information relating to the PSCell change procedure or SPC-Report. For example, in step 807 of FIG. 8, MN 820 can send one message that includes an IE, e.g., successfulPSCellchange-InfoAvailable which is set to “true” to the T-SN, the message can be the existing message (e.g., a SN Reconfiguration Complete message) or a new defined message.

In step 808 of FIG. 8, after T-SN 840 receives the indication, T-SN 840 can request UE 810 to report the successful SN or PSCell change related information (e.g., information relating to the PSCell change procedure stored by the UE or SPC-Report). For example, T-SN 840 can send one message that includes an IE e.g., SPC-ReportReq which is set to “true” to UE 810, the message can be the existing message (e.g., DLInformationTransferMRDC message) or a new defined message.

In step 809 of FIG. 8, after receiving the request from T-SN 840, UE 810 can report the successful SN or PSCell change related information (e.g., information relating to the PSCell change procedure stored by the UE or SPC-Report) to T-SN 840 via SRB3 using a (ULInformationTransferMRDC message or a new defined message.

After receiving the successful SN or PSCell change related information (e.g., information relating to the PSCell change procedure stored by the UE or SPC-Report) from UE 810, T-SN 840 can decide whether RACH configuration for target PSCell needs optimization. If needed, T-SN 840 can optimize RACH configuration(s) for the target PSCell. After step 809 of FIG. 8, one of following three solutions may be performed in different embodiments, i.e., “Solution X” including steps 810 to 811, “Solution Y” including steps 813 to 814, and “Solution Z” including step 812.

### Solution X

In Solution X: in step 810 of FIG. 8, if there is no direct interface between S-SN 830 and T-SN 840, T-SN 840 can send the successful SN or PSCell change related information (e.g., information relating to the PSCell change procedure stored by the UE or SPC-Report) from UE 810 to MN 820 via an existing Xn or X2 message (e.g., RRC Transfer message) or a new defined Xn or X2 message. Then, in step 811 of FIG. 8, MN 810 can send the successful SN or PSCell change related information (e.g., information relating to the PSCell change procedure stored by the UE or SPC-Report) to S-SN 830 via an existing Xn or X2 message (e.g., RRC Transfer message) or a new defined Xn or X2 message. S-SN 830 can make an analysis and may optimize SN or PSCell change related configuration(s) (e.g., a threshold for triggering SN or PSCell change). Optionally, to enable S-SN 830 to identify the association between UE 810 and the successful SN or PSCell change related information (e.g., information relating to the PSCell change procedure stored by the UE or SPC-Report) especially for the case that a context of UE 810 (e.g., source PSCell related UE context) is released in S-SN 830, this Xn or X2 message from MN 820 to S-SN 830 can contain at least one of:
(1) XnAP ID of UE 810 allocated at S-SN 830; XnAP ID of UE 810 allocated at T-SN 840; and/or XnAP ID of UE 810 allocated at MN 820.
(2) X2AP ID of UE 810 allocated at S-SN 830; X2AP ID of UE 810 allocated at T-SN 840; and/or X2AP ID of UE 810 allocated at MN 820.
(3) PSCell change information of UE 810. This is information related to the PSCell change, in order to enable later analysis of the conditions that led to a successful PSCell change. At first, this information is provided by the source SN and/or the MN during SN addition or preparation procedure, if the PSCell change information IE is provided in the SN addition request message, the target SN shall, if supported, store this information.
(4) Source PSCell C-RNTI and/or source PSCell ID (e.g., PCI together with frequency information, and/or CGI).
(5) A context of UE 810.

### Solution Y

In Solution Y, in step 813 of FIG. 8, if there is no direct Xn or X2 interface between S-SN 830 and T-SN 840, T-SN 840 can send information relating to the PSCell change procedure (e.g., the SPC-Report) to MME 850 (if T-SN 840 is connected to MME 850) or AMF 860 (if T-SN 840 is connected to AMF 860) via a S1 interface or a NG interface. Then, in step 814 of FIG. 8, MME 850 or AMF 860 can send the successful SN or PSCell change related information (e.g., information relating to the PSCell change procedure stored by the UE or SPC-Report) to S-SN 830 via a S1 interface or a NG interface. For example, if T-SN 840 is connected to MME 850 or AMF 860, an existing message (e.g., Uplink RAN Configuration Transfer message) or a new message can be used to transfer the SPC-Report (e.g., SPC-Report can be regarded as a container included in the Uplink RAN Configuration Transfer message) from T-SN 840 to MME 850 or AMF 860, and an existing message (e.g., Downlink RAN Configuration Transfer message) or a new message can be used to transfer the SPC-Report (e.g., SPC-Report can be regarded as a container included in the Downlink RAN Configuration Transfer message) from MME 850 or AMF 860 to S-SN 830. S-SN 830 can make an analysis and may optimize SN or PSCell change related configuration(s) (e.g., a threshold for triggering SN or PSCell change).

### Solution Z

In Solution Z, in step 812 of FIG. 8, if there is a direct interface between S-SN 830 and T-SN 840, T-SN 840 can send the successful SN or PSCell change related information (e.g., information relating to the PSCell change procedure stored by the UE or SPC-Report) from UE 810 to S-SN 830 via an existing Xn or X2 message (e.g., RRC Transfer message) or a new defined Xn or X2 message. Optionally, to enable S-SN 830 to identify the association between UE 810 and the successful SN or PSCell change related information (e.g., information relating to the PSCell change procedure stored by the UE or SPC-Report) especially for the case that a context of UE 810 (e.g., source PSCell related UE context) is released in S-SN 830, this Xn or X2 message from T-SN 840 to S-SN 830 can contain at least one of:
(1) XnAP ID of UE 810 allocated at S-SN 830; XnAP ID of UE 810 allocated at T-SN 840; and/or XnAP ID of UE 810 allocated at MN 820.
(2) X2AP ID of UE 810 allocated at S-SN 830; X2AP ID of UE 810 allocated at T-SN 840; and/or X2AP ID of UE 810 allocated at MN 820.
(3) PSCell change information of UE 810. This is information related to the PSCell change, in order to enable later analysis of the conditions that led to a successful PSCell change. At first, this information is provided by the source SN and/or the MN during SN addition or preparation procedure, if the PSCell change information IE is provided in the SN addition request message, the target SN shall, if supported, store this information.
(4) Source PSCell C-RNTI and/or source PSCell ID (e.g., PCI together with frequency information, and/or CGI).
(5) A context of UE 810.

After receiving the successful SN or PSCell change related information (e.g., information relating to the PSCell change procedure stored by the UE or SPC-Report) from T-SN 840 in step 812 of FIG. 8, S-SN 830 can make an analysis and may optimize SN or PSCell change related configuration(s) (e.g., threshold for triggering SN or PSCell change).

Details described in the embodiments as illustrated and shown in FIGS. 1-7 and 9, especially, contents regarding successful SN or PSCell change related information and a trigger condition for storing or logging or setting the successful SN or PSCell change related information, are applicable for the embodiments as illustrated and shown in FIG. 8. Moreover, details described in the embodiments of FIG. 8 are applicable for all the embodiments of FIGS. 1-7 and 9.

FIG. 9 illustrates an exemplary block diagram of an apparatus according to some embodiments of the present application. As shown in FIG. 9, the apparatus 900 may include at least one processor 904 and at least one transceiver 902 coupled to the processor 904. The apparatus 900 may be a RAN node (e.g., a MN, a source SN, or a target SN) or a UE.

Although in this figure, elements such as the at least one transceiver 902 and processor 904 are described in the singular, the plural is contemplated unless a limitation to the singular is explicitly stated. In some embodiments of the present application, the transceiver 902 may be divided into two devices, such as a receiving circuitry and a transmitting circuitry. In some embodiments of the present application, the apparatus 900 may further include an input device, a memory, and/or other components.

In some embodiments of the present application, the apparatus 900 may be a UE. The processor 904 may be configured: to detect a presence of a trigger condition before or during a PSCell change procedure from a source PSCell to a target PSCell in relation to the UE or after successfully completing the PSCell change procedure; and to store information relating to the PSCell change procedure, in response to detecting the presence of the trigger condition.

In some embodiments of the present application, the apparatus 900 may be a RAN node (e.g., a MN). The transceiver 902 may be configured: to transmit a RRC reconfiguration message to a UE; and to receive an indication for information relating to a PSCell change procedure from the UE.

In some embodiments of the present application, the apparatus 900 may be a RAN node (e.g., a source SN). The processor 904 may be configured to initiate a PSCell change procedure in relation to a UE. The transceiver 902 may be configured to receive a message which includes information relating to the PSCell change procedure.

In some embodiments of the present application, the apparatus 900 may be a RAN node (e.g., a target SN). The processor 904 may be configured to participate in a PSCell change procedure in relation to a UE. The transceiver 902 may be configured to receive a message which includes information relating to the PSCell change procedure.

In some embodiments of the present application, the apparatus 900 may further include at least one non-transitory computer-readable medium. In some embodiments of the present disclosure, the non-transitory computer-readable medium may have stored thereon computer-executable instructions to cause a processor to implement the method with respect to a RAN node (e.g., a MN, a source SN, or a target SN) or a UE as described above. For example, the computer-executable instructions, when executed, cause the processor 904 interacting with transceiver 902, so as to perform operations of the methods, e.g., as described in view of any of FIGS. 2-8.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.”

1. A user equipment (UE), comprising:
at least one memory; and
at least one processor coupled with the at least one memory and configured to cause the UE to:
detect a presence of a trigger condition before or during a primary secondary cell (PSCell) change procedure from a source PSCell to a target PSCell in relation to the UE or after successfully completing the PSCell change procedure; and
in response to detecting the presence of the trigger condition, store information relating to the PSCell change procedure.

2. The UE of claim 1, wherein the trigger condition comprises:
successfully completing a random access channel (RACH) procedure to the target PSCell;
a radio problem in a source secondary cell group (SCG) is detected before or during the PSCell change procedure;
a radio problem in a source master cell group (MCG) is detected before or during the PSCell change procedure;
a radio problem in a target SCG is detected after successfully completing the PSCell change procedure;
a beam failure is detected in at least one of the source MCG, the source SCG, and the target SCG, before or during the PSCell change procedure or shortly after successfully completing the PSCell change procedure;
a RACH delay towards the target PSCell during the PSCell change procedure is higher than a delay threshold;
interruption time for the PSCell change procedure is higher than an interruption threshold;
a total number of preambles transmitted towards the target PSCell during the RACH procedure is higher than a number threshold;
a link quality of the target PSCell is lower than a first quality threshold upon successfully completing the PSCell change procedure;
a link quality of the source PSCell is higher than a second quality threshold upon successfully completing the PSCell change procedure;
one or more radio link control (RLC) retransmission counters for the source MCG exceed a first counter threshold;
one or more RLC retransmission counters for the source SCG exceed a second counter threshold;
one or more RLC retransmission counters for the target SCG exceed a third counter threshold;
or a combination thereof.

3. The UE of claim 1, wherein the information relating to the PSCell change procedure comprises:
information relating to one or more radio link monitoring (RLM) procedures for at least one of a source MCG, a source SCG, and a target SCG;
information relating to one or more beam failure detection (BFD) procedures for at least one of the source MCG, the source SCG, and the target SCG;
information relating to the PSCell change procedure;
a RACH delay towards the target PSCell;
interruption time for the PSCell change procedure;
a total number of preambles transmitted towards the target PSCell;
transmission power of the UE for a RACH procedure towards the target PSCell;
location information of the UE;
or a combination thereof.

4. The UE of claim 1, wherein the at least one processor is configured to cause the UE to:
transmit an indication to a network device to indicate an availability of the information relating to the PSCell change procedure.

5. The UE of claim 4, wherein the at least one processor is configured to cause the UE to:
receive a first message from a network device for requesting the information relating to the PSCell change procedure.

6. The UE of claim 5, wherein the at least one processor is configured to cause the UE to:
transmit a second message to the network device, wherein the second message includes the information relating to the PSCell change procedure.

7. The UE of claim 1, wherein the at least one processor is configured to cause the UE to:
receive a RRC reconfiguration message from a master node (MN).

8. A master node (MN), comprising:
at least one memory; and
at least one processor coupled with the at least one memory and configured to cause the MN to:
transmit, to a user equipment (UE), a radio resource control (RRC) reconfiguration message for triggering a primary secondary cell (PSCell) change procedure; and
receive, from the UE, an indication for information relating to the PSCell change procedure.

9. The MN of claim 8, wherein the information relating to the PSCell change procedure comprises:
information relating to one or more radio link monitoring (RLM) procedures for at least one of a source MCG, a source SCG, and a target SCG;
information relating to one or more beam failure detection (BFD) procedures for at least one of the source MCG, the source SCG, and the target SCG;
information relating to the PSCell change procedure;
a RACH delay towards a target PSCell;
interruption time for the PSCell change procedure;
a total number of preambles transmitted towards the target PSCell;
transmission power of the UE for a RACH procedure towards the target PSCell;
location information of the UE;
or a combination thereof.

10. The MN of claim 8, wherein the at least one processor is configured to cause the MN to:
transmit, to the UE, a first message for requesting the information relating to the PSCell change procedure.

11. The MN of claim 8, wherein the at least one processor is configured to cause the MN to:
receive a second message from the UE, wherein the second message includes the information relating to the PSCell change procedure.

12. The MN of claim 11, wherein the at least one processor is configured to cause the MN to:
transmit a third message to at least one of a source secondary node (SN), a target SN, an access and mobility management function (AMF), and a mobility management entity (MME),
wherein the third message includes the information relating to the PSCell change procedure.

13. The MN of claim 12, wherein in response to transmitting the third message to the source SN, the third message comprises:
a Xn application protocol (XnAP) identifier (ID) of the UE allocated at the source SN;
a X2 application protocol (X2AP) ID of the UE allocated at the source SN;
a XnAP ID of the UE allocated at the target SN;
a X2AP ID of the UE allocated at the target SN;
a XnAP ID of the UE allocated at the MN;
a X2AP ID of the UE allocated at the MN;
PSCell change information;
a cell radio network temporary identifier (C-RNTI) of a source PSCell of the UE;
a physical cell identifier (PCI) of the source PSCell together with frequency information;
a cell global identifier (CGI) of the source PSCell; a context of the UE;
or a combination thereof.

14. The MN of claim 8, wherein the at least one processor is configured to cause the MN to:
transmit, to a target SN, the indication to indicate an availability of information relating to the PSCell change procedure.

15. A method performed by a source secondary node (SN), comprising:
at least one memory; and
at least one processor coupled with the at least one memory and configured to cause the source SN to:
initiate a primary secondary cell (PSCell) change procedure in relation to a user equipment (UE); and
receive a first message, wherein the first message includes information relating to the PSCell change procedure.

16. A processor for wireless communication, comprising:
at least one controller coupled with at least one memory and configured to cause the processor to:
detect a presence of a trigger condition before or during a primary secondary cell (PSCell) change procedure from a source PSCell to a target PSCell in relation to the processor or after successfully completing the PSCell change procedure; and
in response to detecting the presence of the trigger condition, store information relating to the PSCell change procedure.

17. The processor of claim 16, wherein the trigger condition comprises:
successfully completing a random access channel (RACH) procedure to the target PSCell;
a radio problem in a source secondary cell group (SCG) is detected before or during the PSCell change procedure;
a radio problem in a source master cell group (MCG) is detected before or during the PSCell change procedure;
a radio problem in a target SCG is detected after successfully completing the PSCell change procedure;
a beam failure is detected in at least one of the source MCG, the source SCG, and the target SCG, before or during the PSCell change procedure or shortly after successfully completing the PSCell change procedure;
a RACH delay towards the target PSCell during the PSCell change procedure is higher than a delay threshold;
interruption time for the PSCell change procedure is higher than an interruption threshold;
a total number of preambles transmitted towards the target PSCell during the RACH procedure is higher than a number threshold;
a link quality of the target PSCell is lower than a first quality threshold upon successfully completing the PSCell change procedure;
a link quality of the source PSCell is higher than a second quality threshold upon successfully completing the PSCell change procedure;
one or more radio link control (RLC) retransmission counters for the source MCG exceed a first counter threshold;
one or more RLC retransmission counters for the source SCG exceed a second counter threshold;
one or more RLC retransmission counters for the target SCG exceed a third counter threshold;
or a combination thereof.

18. The processor of claim 16, wherein the information relating to the PSCell change procedure comprises:
information relating to one or more radio link monitoring (RLM) procedures for at least one of a source MCG, a source SCG, and a target SCG;
information relating to one or more beam failure detection (BFD) procedures for at least one of the source MCG, the source SCG, and the target SCG;
information relating to the PSCell change procedure;
a RACH delay towards the target PSCell;
interruption time for the PSCell change procedure;
a total number of preambles transmitted towards the target PSCell;
transmission power of the processor for a RACH procedure towards the target PSCell;
location information of the processor;
or a combination thereof.

19. The processor of claim 16, wherein the at least one controller is configured to cause the processor to:
transmit an indication to a network device to indicate an availability of the information relating to the PSCell change procedure.

20. The processor of claim 16, wherein the at least one controller is configured to cause the processor to:
receive a first message from a network device for requesting the information relating to the PSCell change procedure.
